(19) United States
(12) Patent Application Publication
(10) Pub. No.: US 2005/0270007 A1
(43) Pub. Date: Dec. 8, 2005

(54) Simplified adaptive control method for power converters

(75) Inventor: Isaac Cohen, Dix Hills, NY (US)

Correspondence Address: MYERS BIGEL SIBLEY & SAJOVEC, PO BOX 37428, RALEIGH, NC, 27627, US

(73) Assignee: LAMBDA ELECTRONICS, San Diego, CA (US)

(21) Appl. No.: 10/709,421

(22) Filed: May 4, 2004

(51) Int. Cl. G05F 1/40

(52) U.S. Cl. 323/285

(57) ABSTRACT

Adaptive control method for regulating the output voltage or current of converters by causing the input current of the converter to be directly proportional to its output current (or respectively its output voltage) and inversely proportional its input voltage. In cases where the input voltage varies slowly or it is constant, the inverse proportionality to the input voltage may be omitted.

### BACKGROUND OF INVENTION

This invention relates to power converters and more particularly to adaptive control techniques for controlling such converters. The applicant's prior U.S. Pat. No. 5,438,505 discloses a power converter regulating technique based on forcing the input current of a converter to follow a signal proportional to the ratio of the output current of the converter to its output voltage (the conductance of the converter's load) or to the ratio of output voltage of the converter to its output current (the resistance of the converter's load).The performance provided by this technique is excellent but the algorithms are calculation intensive so the technique may not be cost-effective for low-end applications. It is an object of the present invention to provide a simplified adaptive control technique that will maintain most of the benefits of the technique disclosed in the U.S. Pat. No. 5,438,505.

### SUMMARY OF INVENTION

The present invention exploits the fact that the filters at the output of power converters consist of relatively large capacitors and inductors that reduce the variation of the output voltage and current of the converter as a result of sudden loads changes.

If the output current or the output voltage of the converter changes relatively slowly as a result of a load transient, a simplified control algorithm can be used that does not require the calculation of the voltage to current ratio (the resistance of the load) or the current to voltage ratio (the conductance of the load). The algorithm of the present invention will use the output current or the output voltage of the converter instead of the conductance or resistance of the load.

### BRIEF DESCRIPTION OF DRAWINGS

FIG. 1 is a block diagram of a converter control based on the prior art.

FIG. 2 is the block diagram of control for converters intended to operate as voltage sources.

FIG. 3 is the block diagram of control for converters intended to operate as current sources.

FIG. 4 is the block diagram of a further simplified control for converters intended to operate as voltage sources.

FIG. 5 is the block diagram of a further simplified control for converters intended to operate as a current sources.

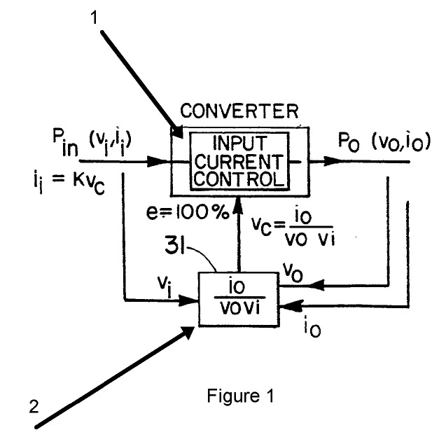

### DETAILED DESCRIPTION

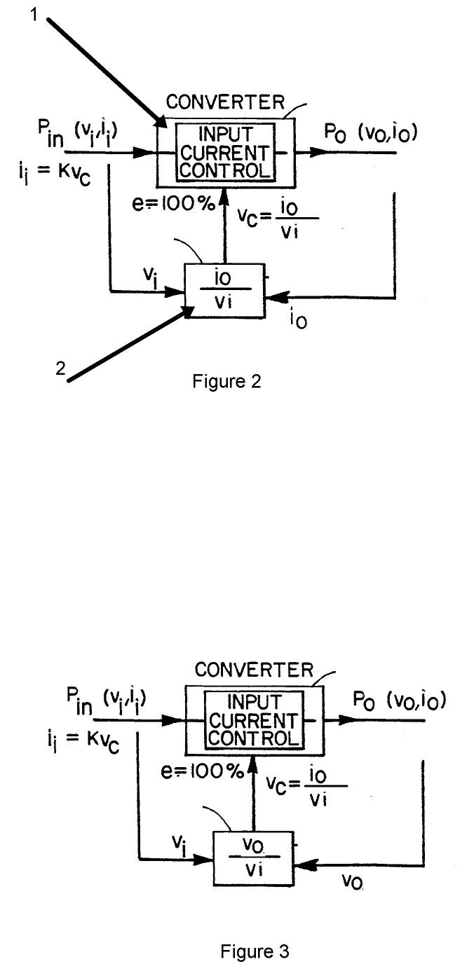

If converter 1 in FIG. 2 has 100% efficiency, its average input power is equal to its average output power:
Vᵢ·Iᵢ=Vₒ·Iₒ 1

Converter 1 is equipped with an internal control loop that forces its input current to be equal with a control signal Vc:
Iᵢ=k·Vc 2

According to one embodiment of the present invention (ref. FIG. 2), the output voltage of converter 1 can be regulated by making reference Vc proportional to the output current Io of the converter and inversely proportional to the input voltage Vᵢ. If the proportionality constant is unity, the control voltage Vc will be equal to:
Vc=Iₒ/Vᵢ 3

Substitutions into equation 2 and 1 yields:
Vᵢ·k·Iₒ/Vᵢ=Vₒ·Iₒ 4

If the output current Iₒ>0, we can divide both sides of equation 3 by Iₒ. The input voltage Vi cancels out, yielding:
Vₒ=k 5

meaning that the output voltage is regulated in respect to changes in both the input voltage and output load.

In some applications (ref. FIG. 3) it might be desirable to operate converter 1 is a current source. In such cases, reference V_{c} is made proportional to the output voltage Vi of the converter and inversely proportional to the input voltage Vᵢ. If the proportionality constant is unity, the control voltage V_{c} will be now equal to:
V_{c}=Vₒ/Vᵢ 6

Substitutions into equation 2 and 1 yields:
Vᵢ*k·Vₒ/Vᵢ=Vₒ*Iₒ 7

If the output voltage is larger than 0, we can divide both sides of equation 3 by Vₒ. The input voltage Vi cancels out, yielding:
Iₒ=k 8

meaning that the output current is regulated in respect to changes in both the input voltage and output load.

According to equations 5 and 8, the control method of the present invention will yield perfect regulation of the output current or voltage of an ideal, 100% efficient converter, provided that all the constants are perfectly accurate and stable and all the mathematical operations are perfectly accurate. In reality, the efficiency of converters is always less than 100%, mathematical operations may not be perfectly accurate and constants tend to drift with time and temperature.

In order to compensate for these errors and improve regulation, a slow, relatively high gain conventional closed loop can be added that will compare the output voltage (or current) of the converter with an appropriate reference and alter the proportionality constants so the output current or voltage of regulated to the desired degree of accuracy.

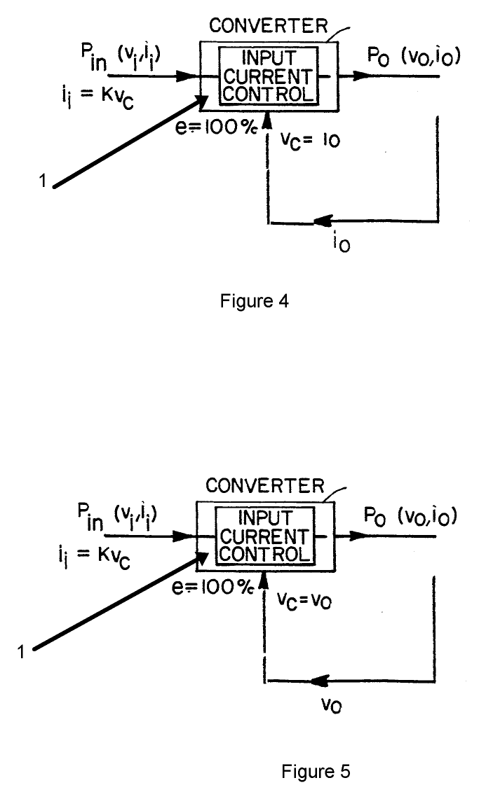

In an yet simpler embodiment of the present invention, the control voltage Vc is made proportional only to either the output current (ref. FIG. 4) or the output voltage, resulting in an output Vo or respectively an output current lo that are not affected by changes in the output load but are proportional to the input voltage.

This embodiment of the present invention will be applied for converters operated with constant (no correction for input voltage changes required) or slowly varying input voltage, where line regulation can be provided by the added conventional loop.

1-4. (canceled)

5. A method of regulating an output voltage or current of a power converter, the method comprising:
regulating the output voltage or current by controlling an input current of the power converter responsive to one of the output current or the output voltage of the power converter.

6. The method of claim 5, wherein regulating the output voltage or current by controlling an input current of the power converter responsive to one of an output current or an output voltage of the power converter comprises regulating the output voltage by causing the input current to be proportional to the output current.

7. The method of claim 6, wherein regulating the output voltage by causing the input current to be proportional to the output current comprises regulating the output voltage by causing the input current to be proportional to the output current and inversely proportional to an input voltage of the power converter.

8. The method of claim 5, wherein regulating the output voltage or current by controlling an input current of the power converter responsive to one of an output current or an output voltage of the power converter comprises regulating the output current by causing the input current to be proportional to the output voltage.

9. The method of claim 8, wherein regulating the output current by causing the input current to be proportional to the output voltage comprises regulating the output current by causing the input current to be proportional to the output voltage and inversely proportional to an input voltage of the power converter.

10. An apparatus comprising:
a power converter; and
a controller configured to regulate an output voltage or current of the power converter by controlling an input current of the power converter responsive to one of the output current or the output voltage of the power converter.

11. The apparatus of claim 10, wherein the controller is configured to regulate the output voltage by causing the input current to be proportional to the output current.

12. The apparatus of claim 11, wherein the controller is configured to regulate the output voltage by causing the input current to be proportional to the output current and inversely proportional to an input voltage of the power converter.

13. The apparatus of claim 10, wherein the controller is configured to regulate the output current by causing the input current to be proportional to the output voltage.

14. The apparatus of claim 13, wherein the controller is configured to regulate the output current by causing the input current to be proportional to the output voltage and inversely proportional to an input voltage of the power converter.
